(19) United States
(12) Patent Application Publication
(10) Pub. No.: US 2007/0132280 A1
(43) Pub. Date: Jun. 14, 2007

(54) Structural element, particularly a hybrid structural element for a cross member of a vehicle and use of a structural element

(75) Inventor: Walter Wolf, Oppenweiler-Zell (DE)

Correspondence Address: FOLEY AND LARDNER LLP;SUITE 500, 3000 K STREET NW, WASHINGTON, DC, 20007, US

(73) Assignee: BEHR GMBH & CO. KG, Stuttgart (DE)

(21) Appl. No.: 10/574,772

(22) PCT Filed: Oct. 8, 2004
(86) PCT No.: PCT/EP04/11282

§ 371 Date: Dec. 13, 2006

(30) Foreign Application Priority Data
Oct. 8, 2003 (DE) 103 47 230.4
Mar. 2, 2004 (DE) 10 2004 010 605.3

(51) Int. Cl. B60K 37/00; B62D 25/14

(52) U.S. Cl. 296/208; 296/70; 180/90; 280/782

(57) ABSTRACT

The invention relates to a structural element (1), particularly a hybrid structural element, for a cross member of a vehicle, in which a base body (2) is provided, which is at least partially lined with plastic (4) and which is provided with at least one flow tap (8a to 8e). Said base body (2) is, in the area of the flow tap (8a to 8e), provided with a flow-guiding means (9).

The invention relates to a structural element, particularly a hybrid structural element, for a cross member of a vehicle. The invention also relates to the use of a structural element of this kind.

Already familiar from the automobile construction industry are cross members formed from tubes, which consist of metal and exhibit appropriately heavy wall thicknesses. The wall thicknesses in this case are of appropriately heavy execution for adequate dimensional, bending, buckling and torsional stability and for adequate load-bearing capacity. The cross member executed as a tubular or hollow profile is suitable in principle for guiding air, for example from an air conditioning system arranged centrally in the front area of the vehicle to lateral discharge outlets.

A cross member of this kind is previously disclosed in DE 100 64 522 A1, for example. In this case, the cross member is executed for the purpose of weight reduction from a lightweight material, in particular from a light alloy, in the form of a shell component or a base body, arranged in which is a plastic core forming at least one channel in order to assure sufficient rigidity and load-bearing capacity of the cross member. To permit the discharge of the air flow, the channel is provided with openings for an air tap.

Flow guidance customarily takes place in this case at each air tap via a routing and guiding element arranged externally on the structural element, in particular involving diverting the flow. What is more, the flow medium, for example air, is led to the routing and guiding element via a single large opening or a plurality of openings in the form of a perforated opening area in the base body of the structural element. In this case, this may lead to a harsh outward flow at the edge of the opening of the base body in the area of the air tap, whereby irregular flows can be generated.

The object of the invention is thus to make available a particularly simple structural element, in which a particularly uniform outward flow is enabled. It is also proposed to describe the use of a structural element.

The object is achieved in accordance with the invention with regard to the structural element by the characterizing features of claim 1, and with regard to the applications for a structural element of this kind by the characterizing features of the independent claims 27 to 30.

Advantageous further developments of the invention are the subject of the dependent claims.

The invention in this case is based on the notion that, in a structural element, such as a hybrid structural element for a cross member of a vehicle, which is in the form of an at least partially plastic-coated base body with at least one flow tap, a harmonious outward flow of a medium that is conducted through the structural element, for example air, should be made possible at the flow tap. In order to make this possible, the structural element should ensure a flow tap with the softest possible flow-guiding means. A flow-guiding means is provided for this purpose in the structural element itself, in particular in the vicinity of the flow tap. A reliable and uniform outward flow through the opening in the structural element is assured by the arrangement of a flow-guiding means in the vicinity of the flow tap. In conjunction with the use of the structural element as a means of guiding air in an air conditioning system in a vehicle, the uniform and soft outward flow of the air leads to an improvement in the comfort of the climate inside the vehicle.

Having regard for the structural element, in particular a hybrid structural element for a cross member of a vehicle, the structural element exhibits an at least partially plastic-coated base body, which is formed from at least two elements, which elements are capable of being connected to one another, in conjunction with which the base body is provided internally with plastic in such a way that the means for guiding the flow is provided in the vicinity of the flow tap. The plastic is arranged in particular in the nature of a plastic structure inside the base body, for example applied by extrusion, joined on or inserted. What is more, the plastic structure exhibits a smaller cross section compared with the cross section of the base body. The base body that is lined partially with plastic can advantageously be of perforated execution, at least in some areas. It is appropriate for this to be effected in the vicinity of an opening, for example. A base body of this kind possesses the particular advantage of saving weight and/or reinforcing the structure.

The flow-guiding means is appropriately executed as a smoothing element. In a particularly simple embodiment, the flow-guiding means, in particular the smoothing element, is formed from a plastic structure of varying thickness. In other words: the smoothing element is itself formed by the plastic of the base body, in that the plastic lining or the plastic structure exhibits a varying thickness in the vicinity of the flow tap. For example, the plastic structure exhibits a thickness of 1 mm to 10 mm, and in particular 2 mm to 6 mm. Moreover, the plastic structure can be executed, at least in some areas, in a multi-layered fashion, and in particular from a combination of hard and soft layers, with a view to improving the acoustics.

In one possible embodiment of the smoothing element, the plastic structure is formed by an arched thickening in the flow tap. A soft flow-guiding means is assured by arching of this kind in the vicinity of the flow tap, in particular in the vicinity of the opening for the outward flow.

Alternatively or additionally, the flow-guiding means is executed as a deflection element. In addition to the softest possible means for guiding the flow, a flow deflection, for example in the direction of the opening for the outward flow, is assured in this way. In the case of one possible embodiment, a deflection element extends from a layer of plastic on the inner wall in the form of an arc, and in particular in the form of a tongue, into the cavity of the base body, so that the deflection element runs essentially perpendicularly to the direction of flow, in particular in an upward or downward direction, and brings about a deflection of the flow. Alternatively, the deflection element may run vertically viewed in the longitudinal direction of the base body, and may then extend laterally in the form of an arc, so that the deflection element runs transversely to the direction of the flow, in particular in the lateral sense, and brings about a deflection of the flow to the side. Depending on the embodiment, the deflection element can be executed on the one hand as a separate module, which is capable of being joined to the plastic layer. On the other hand, the plastic layer and the deflection element can be executed as a module, in particular a plastic module in the form of a plastic structure.

Depending on the execution of the structural element, and in particular its base body, for example in the case of an embodiment as a multi-chamber channel intended to guide a plurality of flow media, a plurality of deflection elements can be arranged parallel next to one another in the base body viewed in the longitudinal direction, in particular in the vicinity of the flow tap. The deflection elements in this embodiment form a partition wall between the individual chambers of the channels.

Alternatively or additionally, the flow-guiding means can be executed as a combined guiding and reinforcing element. In addition to a soft flow-guiding means and a possible deflection of the flow, an adequately good rigidity, in particular an adequately good torsional, bending and buckling stability is additionally assured for the base body in this way. For example, the combined guiding and reinforcing element is formed by a channel element, a deflection element arranged in the channel element, and at least one reinforcing element supported by the channel element against the base body. What is more, the channel element exhibits a reducing cross section viewed in the direction of the flow tap, in conjunction with which the reinforcing element is arranged in the form of transverse ribs in the cavity formed between the channel element and the base body. The angle of the transverse ribs in this case can run perpendicular to the channel or obliquely at an angle of 0° to ±60°. That is to say, the ribs stand parallel to one another or delimit a maximum angle of 120°, and preferably 90° or 0°.

Depending on the embodiment of the combined guiding and reinforcing element, the deflection element can extend from the channel element in the form of an arc, and in particular in the form of a tongue, and can close this in the vicinity of the flow tap at the end of the combined guiding and reinforcing element, in conjunction with which the deflection element discharges into the outflow opening in the base body.

This should be done wherever possible without forming edges against which a flowing medium can impact.

Depending on the manufacturing process for the structural element, the flow-guiding means is executed at least partially or completely separately and is capable of being introduced into the base body. Alternatively, the flow-guiding means can be included with the plastic lining of the base body in a single process step in a so-called single-component or multi-component injection molding process, and can be molded as a plastic structure. The elements are preferably designed in such a way that simple open-closed tools can be used.

A plurality of flow-guiding means, in particular a smoothing element, a deflection element and/or a combined guiding and reinforcing element, are preferably arranged in a single flow tap. For example, the base body viewed in the longitudinal direction is provided with a plurality of flow taps situated at a distance from one another. In a vehicle, for example, the interior of the vehicle can be provided in this way with an air flow at multiple points, for example in the area of the front screen, the side windows, the front area and/or the foot area. Alternatively or additionally, the base body viewed in the transverse direction can be provided with opposing flow taps. The outward flow of the medium upwards and/or downwards is permitted in this way, depending on the arrangement of the structural element. In the case of a structural element assembled from two half shells, for example, the flow tap can be so arranged as to extend across the shells, that is to say on the parting plane between the two half shells, and/or in a shell-specific fashion, that is to say on the half shell itself in each case.

In order to achieve the best possible supporting structure and supporting construction of the structural element, the base body is appropriately, at least partially and in particular along its longitudinal extent, coated by the plastic, and in particular extrusion-coated. Alternatively or additionally, the plastic can be preformed separately and then inserted into the base body. The base body is preferably provided with plastic internally and/or externally. The plastic is also applied in one or more layers and/or with a wall thickness that varies in different areas. In order to achieve the best possible bending, buckling and torsional stability of the structural element, the plastic should preferably be applied with positive engagement and over the entire surface. In addition to providing good structural rigidity, the plastic layer also offers thermal insulation and/or acoustic insulation in a plastic structure that is executed as a channel, through which a medium flows in the form of a gas or a liquid. In addition, one of the layers of plastic can be provided with a reinforcement, and in particular with a reinforcing woven fabric, with fibers, spheres or other materials, for example a fiberglass cloth. For better thermal and acoustic insulation, the layer of plastic can be executed as a foam. PU foam, hard or soft foam, integral foam, can be caused to foam by physical or chemical means for this purpose (TSG thermoplastic foam extrusion molding, Mucell process, etc.), or can be applied in a multi-layer form, in conjunction with which individual layers can exhibit different thicknesses.

A base body executed from a metal and/or a light metal, in particular aluminum, magnesium, titanium or refined steel, with a wall thickness of 0.4 mm up to 1.5 mm, up to 2.0 mm or even up to 3.0 mm, in particular depending on the strength of the material, is preferably used. Depending on the nature and the function of the structural element, the base body can be formed with a varying wall thickness in different areas. For example, in the event that the structural element is used as a transverse member, this can be executed with a greater wall thickness in the vicinity of mountings and power inlet points in the vehicle, for example in the vicinity of a connection to an A-pillar, in the vicinity of the steering, in the area of the connection of an air conditioning system, or, in the case of so-called front-end structural members, in the vicinity of longitudinal members, engine mountings or the bonnet lock, than in the area in which the structural element serves only as an air duct, as an assembly support or for other functions. The metal sheets used for the base body are available under the designations “tailored blanks” (assembled by welding in certain areas), “tailored rolled blanks” (rolled with a different thickness in the direction of rolling), “profiled strip” (e.g. thick edge, thin center), or as “patch-work sheets” (as in a puzzle, although each part attached to the blank has a different wall thickness). A metal base body of this kind or a sheet component of this kind is particularly economical and is particularly suitable for use in the automobile construction industry in a lightweight assembly designed to achieve a reduction in weight.

The structural element described above is preferably used as an instrument panel in a vehicle, in conjunction with which the plastic core or the plastic structure forms one or more channels, in particular an air-guiding channel and/or a cable duct. Alternatively, a structural element of this kind can be used as a cross member in a vehicle, in particular as a cross member between the A-pillars of a vehicle.

The advantages achieved with the invention are in particular that, by means of a flow-guiding means arranged in the vicinity of the flow tap, a soft outward flow of the flow medium is permitted, so that the comfort of the climate in the vicinity of the outward flow is increased. Furthermore, the component can be manufactured with a particularly simple tool. If necessary, the function of the air guiding means can also be disconnected from the static function of the base body in other areas of the flow-guiding means. In this way, deflections can be of a softer and larger execution.

Illustrative embodiments of the invention are explained in more detail with reference to a drawing, in which:

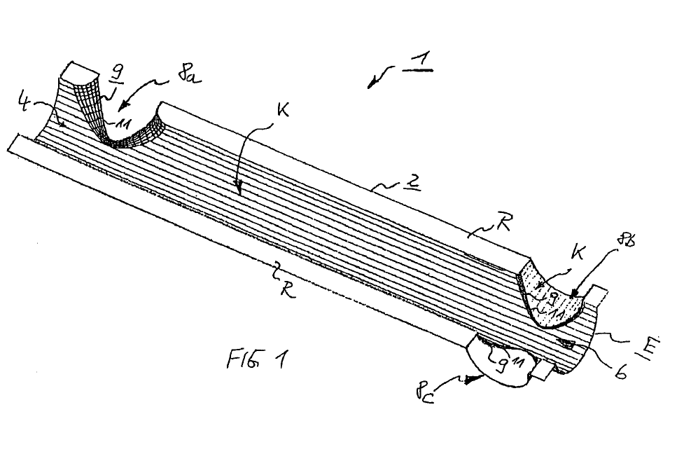

FIG. 1 illustrates schematically an embodiment of a structural element, in particular for a half body of the structural element, with a flow tap and arranged therein means for guiding the flow;

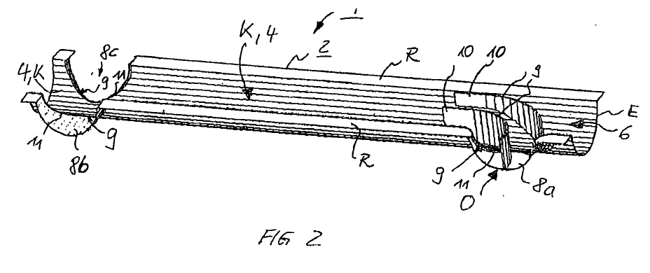

FIG. 2 illustrates schematically an alternative embodiment for a flow-guiding means;

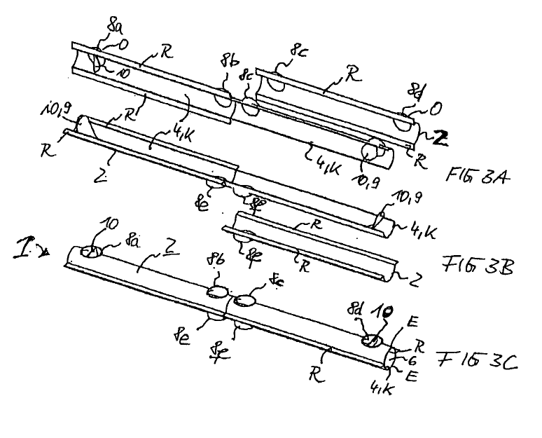

FIGS. 3A to 3C illustrate schematically a perspective view of a structural element having a base body at least partially lined with plastic with a plurality of flow taps and flow-guiding means;

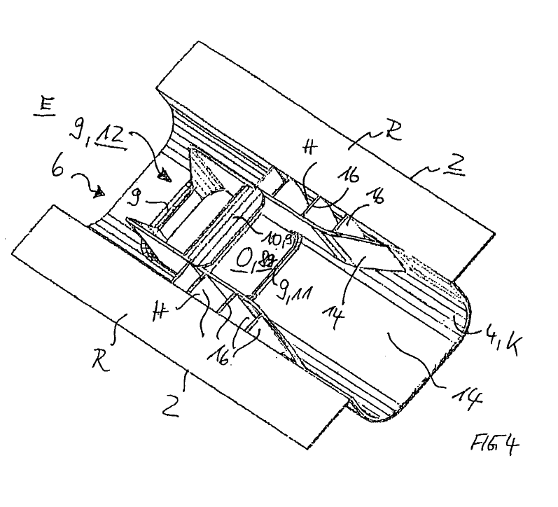

FIGS. 4 to 6 illustrate schematically various embodiments of a structural element, in particular for a half body of the structural element, having a flow tap and a flow-guiding means arranged therein;

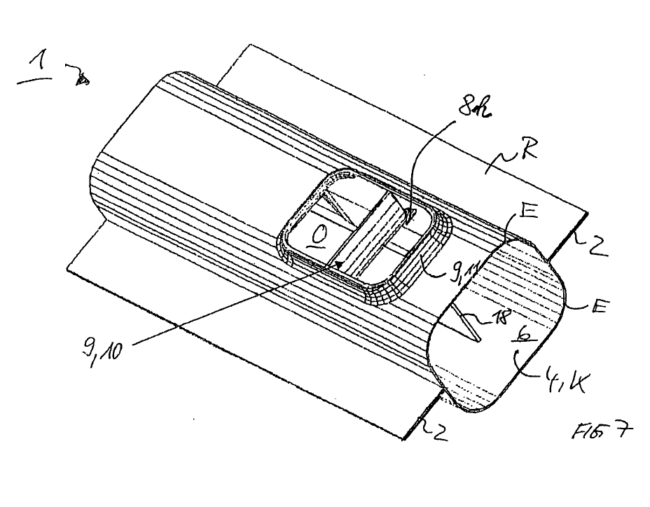

FIG. 7 illustrates schematically a perspective view of a closed structural element having a flow tap and a flow-guiding means arranged therein;

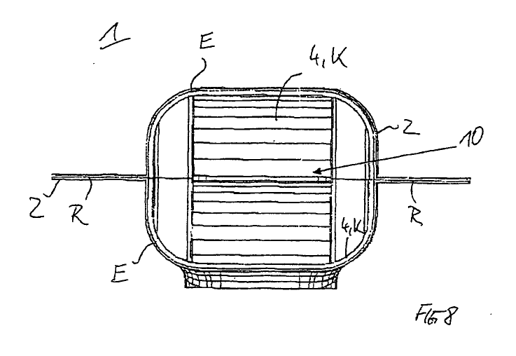

FIG. 8 illustrates schematically in cross section a structural element having a flow-guiding means arranged in the vicinity of a flow tap.

Corresponding component parts are provided with identical designations in all the figures.

FIG. 1 illustrates a view from above of an element E of a structural member 1, for example a transverse member, for arrangement between the A-pillars, not shown in greater detail, of a vehicle, not shown here in greater detail.

The structural element 1 consists, for example, of at least two elements E, of which a lower element E, for example a half body or a half shell, is represented in FIG. 1. The upper element, not shown here in greater detail, is executed so that it corresponds to the lower element E as a half body or a half shell. The structural element 1 exhibits a base body 2, which is preferably made from sheet metal, in particular from a light metal sheet, for example made from aluminum sheet or magnesium sheet, or from fine steel sheet. The base body 2 is executed in its closed state in the illustrative embodiment, that is to say with the two elements E lying one on top of the other as a hollow profile, and in particular as a tubular hollow profile. Alternatively, the base body 2 can also be executed as a hollow profile with a box-like cross section, and/or it can be of perforated execution at least in parts. In one possible embodiment with a box-shaped cross section, the base body 2 is made of two elements E, for example a U-profile or an under shell and a lid.

Alternatively, the base body 6 can also be executed as a hollow profile with a box-like cross section and/or can be of perforated execution at least in parts.

The base body 2 is provided on the inside with plastic 4, which forms a plastic structure K. The plastic 4 in this case can be applied in the form of a plastic lining by joining, insertion or extrusion. The base body 2 that is lined at least partially with the plastic 4 serves in its closed state as a channel 6, in particular as a flow channel and/or a guide channel for the purpose of guiding a flow or for routing cables or other components.

In order to permit the best possible utilization of the channel 6 formed by the plastic structure K for guiding a medium, for example air for the air conditioning of a vehicle interior or, alternatively, for routing lines or cables, the two elements E must be secured to one another sufficiently via the edges R. The edges R in this way form the parting plane between two elements E. For this purpose, with the base body 2 in its closed state, the elements E are connected to one another at their edges R that are superimposed one on top of the other by mechanical means and/or with positive bonding between the materials. To this end, the base body 2 can be connected by caulking on the mutually opposing edges R of the elements E by riveting, screwing, welding, gluing, folding, caulking, clinching or in some other way. In addition, the base body 2, and in particular its two elements E, can be held together via the plastic 4 at the edges R at openings, for example projections, that are not illustrated here in greater detail. The plastic 4 in this case is joined to the base body 2 and is attached to the base body 2 via self-adhesion brought about, for example, by a thermal process.

The plastic structure K formed from the plastic 4 serves the purpose, in the form of a plastic lining, among other things of increasing the rigidity of the base body 2. When air flows through it, the base body 2 of particularly thin-walled execution gives rise to the generation of noise, which is damped to particularly great advantage by lining the base body 2 with the plastic 4. That is to say, the plastic 4 assumes an acoustic insulation function and, if appropriate, a thermal insulation function, too.

To permit the outward flow of the medium that is guided inside the channel 6, for example into the interior of a vehicle, the base body 2 exhibits at least one flow tap 8a to 8c. Three flow taps 8a to 8c are illustrated in FIG. 1. A flow-guiding means 9 is provided in the vicinity of each of the flow taps 8a to 8c to ensure a harmonious outward flow of the medium. The flow-guiding means 9 represented in FIG. 1 is executed in this case as smoothing elements 11, in conjunction with which the plastic structure K exhibits a varying thickness in the vicinity of each of the flow taps 8a or 8b, so that a soft or hard flow tap is caused to occur. In other words: the thickness of the plastic structure K or the thickness of the plastic 4 is adapted locally to a stipulated flow profile in the vicinity of the flow tap 8a to 8c concerned. The plastic structure K exhibits a thickness of 0.1 mm to 10 mm, and in particular from 2 mm to 6 mm. The plastic structure K in this case can also be of multi-layered execution in different areas. Depending on the nature of the guidance of the flow—soft or hard guidance of the flow—in the vicinity of the flow tap 8a, 8b, 8c in each case, the plastic structure K concerned exhibits a greater thickness from 4 mm to 6 mm in the form of an arched thickening or a reduced thickness from 2 mm to 4 mm in the form of a flattened or slightly rounded thickening. As an alternative, instead of areas of increased or reduced thickening, radiuses of different sizes can be selected in the vicinity of the flow tap 8a to 8c in each case.

Alternatively or additionally, at least one deflection element 10 can be arranged in the vicinity of the flow tap 8a in each case as a further means 9 for guiding the flow, as illustrated in FIG. 2. Depending on the nature and the embodiment of the deflection element 10, this can be executed as a separate plastic module, which is joined to the plastic structure K. Alternatively, the deflection element 10 can be executed with the plastic structure K or the plastic layer as a single module, which is included in a so-called single-component or multi-component injection molding process. As illustrated in FIG. 2, a plurality of deflection elements 10 can be arranged parallel with one another viewed in the longitudinal direction of the structural element 1, each of which discharges separately into the flow tap 8a in question in an opening O of the base body 2. For the purpose of deflecting the medium guided in the longitudinal direction in the channel 6 in the direction of the opening O, the deflection elements 10 exhibit a curved path, so that the medium is deflected in the direction of the opening O and is caused to flow out there. In addition, a harmonious outward flow of the medium through the opening O is caused to occur by the plastic structure K having a slightly arched thickened area (=smoothing element 11) in the vicinity of the flow tap 8a. The outermost deflection element 10 is able at the same time to serve as a closure for the end of the channel.

Furthermore, the deflection elements 10 are arranged vertically in the base body 2, in particular in each element E, so that the channel 6 is subdivided into a plurality of chamber channels by means of the deflection elements 10 in the form of partition walls. An embodiment of this kind is used, for example, in a channel 6 executed as a so-called multi-chamber channel, in which a plurality of mediums, for example fresh air, cold air and/or warm air, are conducted. The various mediums can then be mixed as they flow out. The various chambers can also lead to various outlets. The corresponding upper element E of the base body 2 is executed accordingly, as represented in greater detail in FIGS. 3A to 3C.

FIGS. 3A and 3B show the structural element 1 in its opened state, where FIG. 3A shows the upper element E of the structural element 1 and the plastic structure K attached on the inside to the upper element E by joining, insertion or extrusion, and FIG. 3B shows the corresponding lower element E and the plastic structure K on the inside. FIG. 3C shows the structural element 1 in the closed state with the six flow taps 8a to 8f, in conjunction with which deflection elements 10 are arranged in the flow taps 8a and 8d to deflect the flow. As illustrated in FIGS. 3A and 3B, each of the deflection elements 10 in this case extends from the plastic layer or structure K on the inside wall in the form of an arc, and in particular in the form of a tongue, into the cavity, and in particular into the channel 6, of the base body 2. In this way, the channel 6 is closed off at the end, and the medium is deflected in the direction of the opening O by means of the deflection element 10. Depending on the arrangement of the flow taps 8a to 8f, these are arranged in a shell-specific manner, as represented. Alternatively or additionally, these can also be so arranged as to extend across the shells on the parting plane between two elements E.

The base body 2 is executed as a hollow cylinder, which is formed from the two elements E in the form of half shells. The two elements E in the form of half shells together form a circular cross section and exhibit projections which form the edges R for a mechanical and/or positively bonded connection. As an alternative, although not illustrated in greater detail here, the structural element 1 can exhibit a largely box-shaped cross section or, for that matter, almost any other cross sections. Moreover, the elements E can be connected indirectly via the plastic 4 itself.

Depending on the nature and execution of the structural element 1, the element E in each case together with the associated half-shaped plastic structure K can form a single part that is capable of prefabrication. For this purpose, in the vicinity of the shell mold for the element E in each case, the plastic 4 is attached by extrusion, insertion or joining, so that the base body 2 is lined at least partially, and in particular extrusion-coated or foam-coated, with a plastic layer in the form of the plastic structure K. The plastic 4 is introduced for this purpose, for example via at least one channel, not illustrated here in greater detail, with a preset extrusion pressure, into the molding and jointing tool for the single-sided or two-sided, and complete or partial, coating of the base body 2, for example in an injection molding process, and in particular in a single-component or multi-component injection molding process, in the case of a completely coated structural element 1 that is coated on one side or both sides. Alternatively, and depending on the nature of the plastic 4, this can also be injected as a foam, poured or introduced in some other way.

The plastic layer or the plastic 4 exhibits, independently of the nature and manner of its lining and depending on the specification—whether in extruded or joined form—a thickness from 0.1 mm to 10 mm, and preferably between 0.8 mm and 6 mm. The base body 2 can be provided with a layer of plastic 4 internally and/or externally. In addition, by the application of plastic in a number of phases, this can be formed on the base body 2 in one or more layers. The prefabricated elements E of the metallic base body 2 with the plastic structure K are then assembled on the structural element 1 in accordance with FIG. 3C.

In order to obtain the lightest possible structural element 1, which in addition is capable of particularly easy molding, the metallic base body 2 is preferably produced from a base body 2 made from a light metal, in particular aluminum or magnesium, or from fine steel, with a wall thickness from 0.4 mm to 2.0 mm, or up to 3.0 mm. The base body 2 is preferably formed with a wall thickness that varies in certain areas, so that further elements, for example a steering mechanism, an air conditioning unit, and air inlets and/or air outlets, can be integrated on the structural element 1.

FIGS. 4 to 6 illustrate in each case a view from above of an element E, for example a lower or an upper element E of the structural element 1, having a combined guiding and reinforcing element 12 arranged in the vicinity of a flow tap 8g as a means 9 for guiding the flow. In this case, the combined guiding and reinforcing element 12 is produced from a channel element 14, for example an air guiding channel, a deflection element 10 arranged inside the channel element 14, and at least one reinforcing element 16 supported by the channel element 14 against the base body 2. For example, the plastic structure K is executed for this purpose as a flow structure and a conducting and guiding structure having corresponding diversion forms combined with a reinforcing structure in the form of internal ribbing.

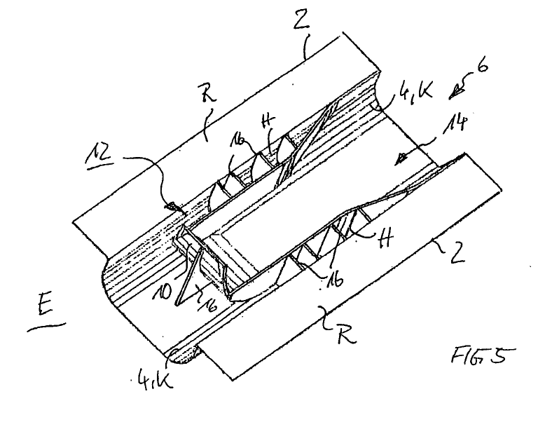

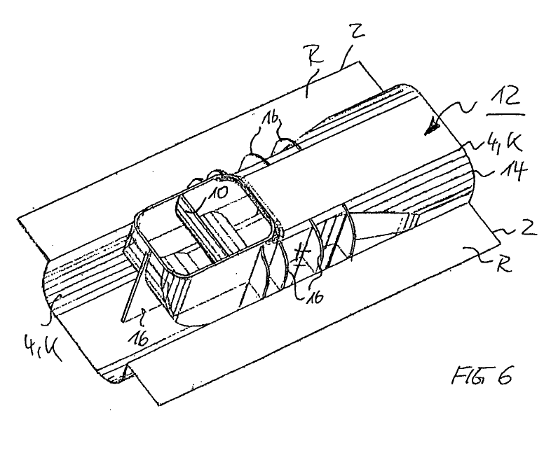

The channel element 14 in this case exhibits a decreasing cross section viewed in the direction of the flow tap 8g concerned. The deflection element 10 extends from the channel element 14. Depending on the embodiment of the flow tap 8g, for example of single-channel or multiple-channel execution, the deflection element 10 closes off the channel 6 at its end, for example in the case of a single-channel flow tap 8g, and discharges into the opening O in the structural element 1, as illustrated in FIG. 5. Represented in each case in FIGS. 4 and 6 is a multiple-channel flow tap 8g, in conjunction with which the deflection element 10 subdivides the opening O in the form of a partition wall into two outflow channels.

The reinforcing elements 16 are arranged in the form of transverse ribs inside a cavity H formed between the channel element 14 and the base body 2. The angle of the transverse ribs in this case can run perpendicular to the channel 6 or obliquely at an angle of 0° to ±60°. That is to say, the ribs stand parallel to one another or delimit a maximum angle of 120°, and preferably 90° or 0°. A base body 2 provided with a plastic structure K of this kind permits a particularly good dimensional rigidity and dimensional structure, so that, in the case of a thin-walled base body 2, this is provided with adequate dimensional and buckling rigidity by a correspondingly formed plastic structure K.

Illustrated in FIGS. 4 and 5 in each case is a half-open channel element 14, which forms a closed channel 6, in particular a flow channel, through the second element E corresponding to the element E concerned of the structural element 1, which is also provided with a half-open channel element 14, in the closed state of the structural element 1—in the case of elements E arranged one on top of the other. Illustrated as an alternative to this in FIG. 6 is a combined guiding and reinforcing element 12 with a closed channel element 14. In this case, either the combined guiding and reinforcing element 12 is capable of prefabrication, for example as a separate module, which is introduced into or joined to the metallic base body 2, or the halves in each case are attached to the base body 2 in each case.

FIG. 7 shows a further embodiment for a flow tap 8h with a plurality of means 9 for guiding the flow—a deflection element 10 and a smoothing element 11 (=arched thickening of the plastic structure K in the edge area of the opening O). A closing element 18 in this case serves as a reinforcing rib for the closure of the channel. Alternatively or additionally, the closing element 18 can also serve as a form of partition wall or separating element. In this case, the channel 6 is then executed as a multi-chamber channel by the separating element running in the longitudinal direction of the structural element 1. For this purpose, the separating element should lie in the separating or parting plane of the two half shells, so that two channel outlets are created. Two flow mediums are conveyed in this way by means of the deflection element 10 in the direction of the opening O at the flow tap 8e, where they can then be mixed. The deflection element 10 represents a deflection element and guide element for a single-chamber channel, so that, after the deflection, the most homogeneous possible distribution of the volume and velocity of the air takes place over the cross section. Without the deflection element 10, the mass flow would be disproportionately high in the outer area, and reverse flow phenomena could even occur at the inner edge.

FIG. 8 shows one possible embodiment of the structural element 1 in cross section in the vicinity of one of the flow taps 8a to 8h with a deflection element 10 arranged therein.

The structural element 1 serves, for example, as an instrument panel supporting member for an air conditioning and/or heating system. Alternatively, the structural element 1 can serve as a transverse member arranged under a windshield in a vehicle, which member is intended as an air guiding channel for the air conditioning of the vehicle interior and for de-icing the windshield or front screen. The base body 2 is provided with a plurality of flow taps 8a to 8h arranged at a distance from one another viewed in the longitudinal direction with openings O for the inlet and/or outlet of a medium conducted in the channel 6, for example air. The number and arrangement of the inlets and outlets can, of course, be varied at will. Moreover, an inlet or outlet can also be present in the vicinity of the edges R and can extend both inside only one shell of the base body 2 and over both shells.

Furthermore, such a structural component 1 can also be used at other locations in a vehicle. Examples are: A-, B-, C-, D-pillars, longitudinal members, sills, roof structural elements, etc. The air from an air conditioning system (abbreviated to HVAC) can also be conducted and distributed in a space-saving manner through these structural elements 1, in conjunction with which the structural element 1 is executed as a structural element in the vehicle, and in particular as a hollow structural element.

### List Of Reference Designations

1 Structural element
2 Base body
4 Plastic
6 Channel
8a to 8h Flow taps
9 Means for guiding the flow
10 Deflection element
11 Smoothing element
12 Combined guiding and reinforcing element
14 Channel element
16 Reinforcing element
18 Separating element
E Elements
H Cavity
K Plastic structure
O Opening
R Edge

1. A structural element, particularly a hybrid structural element, for a cross member of a vehicle, comprising a base body at least partially lined with plastic, which is provided with at least one flow tap (8a to 8e), in conjunction with which the base body is provided, in the area of the flow tap, with a flow-guiding means.

2. The structural element as claimed in claim 1, in which the flow-guiding means is executed as a smoothing element.

3. The structural element as claimed in claims 1, in which the flow-guiding means, in particular the smoothing element, is executed as a plastic structure of varying thickness.

4. The structural element as claimed in claim 3, in which the plastic structure exhibits a thickness of 0.1 mm to 10 mm.

5. The structural element as claimed in claims 3, in which the plastic structure is executed, at least partially, in a multi-layered fashion, and in particular from a combination of hard and soft layers.

6. The structural element as claimed in claim 3, in which the smoothing element is formed by an arched thickening of the plastic structure.

7. The structural element as claimed in claim 1, in which the flow-guiding means is executed as a deflection element.

8. The structural element as claimed in claim 1, in which the deflection element extends from a layer of plastic on the inner wall in the form of an arc into the cavity of the base body.

9. The structural element as claimed in claims 7, in which the deflection element is executed separately and is joined to the plastic layer.

10. The structural element as claimed in claim 7, in which the deflection element is executed in a single piece with the plastic lining.

11. The structural element as claimed in claim 7, in which a plurality of deflection elements are arranged parallel next to one another viewed in the longitudinal direction.

12. The structural element as claimed in claim 1, in which the flow-guiding means is executed as a combined guiding and reinforcing element.

13. The structural element as claimed in claim 12, in which the combined guiding and reinforcing element is formed by a channel element, a deflection element arranged in the channel element, and at least one reinforcing element supported by the channel element against the base body.

14. The structural element as claimed in claims 12, in which the channel element exhibits a reducing cross section viewed in the direction of the flow tap.

15. The structural element as claimed in claim 12, in which the deflection element extends from the channel element in the form of an arc and closes this in the vicinity of the flow tap at the end of the combined guiding and reinforcing element and discharges into an opening in the base body.

16. The structural element as claimed in claim 12, in which a plurality of reinforcing elements are arranged in the form of transverse ribs in the cavity formed between the channel element and the base body.

17. The structural element as claimed in claim 16, in which the angle of the transverse ribs runs perpendicular to the channel or obliquely at an angle of 0° to ±60°.

18. The structural element as claimed in claim 1, in which the flow-guiding means is executed at least partially or completely separately and is capable of being introduced into the base body.

19. The structural element as claimed in claim 1, in which a plurality of flow-guiding means in particular a smoothing element, a deflection element and/or a combined guiding and reinforcing element, are arranged in a single flow tap.

20. The structural element as claimed in claim 1, in which the flow-guiding means discharges in the vicinity of the flow tap into an opening in the base body.

21. The structural element as claimed in claim 1, in which the base body viewed in the longitudinal direction is provided with a plurality of flow taps situated at a distance from one another.

22. The structural element as claimed in claim 1, in which the base body viewed in the transverse direction is provided with opposing flow taps.

23. The structural element as claimed in claim 1, in which the base body is provided at least partially with a plastic layer, and in particular is extrusion-coated or foam-coated.

24. The structural element as claimed in claim 1, in which the base body is executed from a metal, a light metal or its alloys, and in particular aluminium, magnesium, titanium or refined steel, and exhibits a wall thickness from 0.4 mm to 2.0 mm.

25. The structural element as claimed in claim 1, in which the base body exhibits a wall thickness that varies in different areas.

26. The structural element as claimed in, in which the base body is lined in areas with a material of varying wall thickness that has been caused to foam by physical or chemical means.

27. Use of a structural element as claimed in any claim 1 as an instrument panel supporting member in a vehicle with a channel, in particular with at least one air guiding channel and/or a cable duct.

28. The use of a structural element as claimed in claim 1 as a cross member in a vehicle, in particular as a cross member between the A-pillars of a vehicle or as a front-end structural member.

29. The use of a structural element as claimed in claim 1 as a structural element in a vehicle, in particular as a hollow structural element, as a longitudinal member, sill, center tunnel structure, front, side or transverse member, vertical structural element, A-, B-, C-, D-pillar, or roof structural element.

30. The use of a structural element as claimed in claim 1 as a structural element in a vehicle, in particular as a hollow structural element, through which the air for a heating, cooling, air conditioning or ventilation device is conducted.
